(19) United States
(12) Patent Application Publication
(10) Pub. No.: US 2026/0159535 A1
(43) Pub. Date: Jun. 11, 2026

(54) METHOD FOR PRODUCING OLIGOFURAN COMPOUND CONTAINING REACTIVE SILYL GROUP, AND OLIGOFURAN COMPOUND CONTAINING REACTIVE SILYL GROUP

(71) Applicant: NATIONAL UNIVERSITY CORPORATION GUNMA UNIVERSITY, Gunma (JP)

(72) Inventors: Yuya TACHIBANA, Gunma (JP); Shunsuke BEPPU, Gunma (JP); Ken-ichi KASUYA, Gunma (JP)

(73) Assignee: NATIONAL UNIVERSITY CORPORATION GUNMA UNIVERSITY, Gunma (JP)

(21) Appl. No.: 18/706,503

(22) PCT Filed: Oct. 26, 2022
(86) PCT No.: PCT/JP2022/040026

§ 371 Date: May 1, 2024

(30) Foreign Application Priority Data
Nov. 2, 2021 (JP) 2021-179202

(51) Int. Cl. C07F 7/08

(52) U.S. Cl. CPC C07F 7/0814; C07F 7/0829

(57) ABSTRACT

Provided is a method of producing a dihydrosilyloligofuran compound, the method including: a deprotonation step of deprotonating an oligofuran compound in the presence of a deprotonating agent; and a silylation step of allowing a deprotonated product of the oligofuran compound to react with a halohydrosilane compound, in which method the oligofuran compound is a di- to 256-mer of a monofuran compound.

### TECHNICAL FIELD

The present invention relates to: a method of producing a reactive silyl group-containing oligofuran compound; and a reactive silyl group-containing oligofuran compound.

### BACKGROUND ART

Organosilicon compounds, in which a π-conjugated skeleton and a silicon element are linked, have a σ-π conjugation with a compound having a π-conjugation and, therefore, have been developed into organic semiconductor materials. Conventionally, as such organosilicon compounds, structures in which thiophene rings, benzene rings, or the like are linked are used.

In recent years, compounds having an oligofuran skeleton in which plural furan rings are directly linked via carbon-carbon bonds have been attracting attention as novel organic semiconductor materials. For example, it has been reported that the most stable structure of a bifuran skeleton formed of two furan rings that are linked via a carbon-carbon bond is an anti-conformation having a dihedral angle of 180°, and is thus likely to have a high planarity and exhibit excellent semiconductor properties (Non-patent Documents 1 and 2). Accordingly, it is desired to develop a novel bifuran compound and other oligofuran compounds that can function as an organic semiconductor.

Trimethylsilyl group-introduced bifuran compounds have been synthesized so far. For example, Non-patent Document 3 discloses a method of producing 5,5′-bis(trimethylsilyl)-2,2′-bifuran by deprotonating 2,2′-bifuran with n-butyl lithium and allowing the resultant to react with chlorotrimethylsilane.

### PRIOR ART DOCUMENT

### Non-Patent Document

[Non-patent Document 1] J. Phys. Chem. A 2002, 106, 15, 3823-3827
[Non-patent Document 2] J. Chem. Theory Comput. 2014, 10, 9, 3647-3655
[Non-patent Document 3] Org. Chem. Front. 2014, 1, 391-394

### SUMMARY OF INVENTION

### Technical Problem

However, the conventional method disclosed in Non-patent Document 3 is not suitable for industrial production since it has a low 5,5′-bis(trimethylsilyl)-2,2′-bifuran yield of about 25%. In addition, since a trimethylsilyl group is an inert functional group, there is also a problem that it is difficult to expand the use of the method to other silylbifuran derivatives based on modification of a trimethylsilyl group, or polymer materials obtained by polymerization. Therefore, it is demanded to develop a reactive silyl group-introduced oligofuran compound as well as a method by which such an oligofuran compound can be produced with a high yield.

An object of the present invention is to provide: a method by which an oligofuran compound containing a hydrosilyl group as a reactive silyl group can be produced with a high yield; and a novel oligofuran compound containing a hydrosilyl group as a reactive silyl group.

### Solution to Problem

The present inventors intensively studied to solve the above-described problems and consequently discovered that a dihydrosilyloligofuran compound can be produced with a high yield by deprotonation of an oligofuran compound and subsequent hydrosilylation of the oligofuran compound by a reaction with a halohydrosilane compound, thereby completing the present invention. That is, the gist of the present invention is as follows.

[1] A method of producing a dihydrosilyloligofuran compound, the method comprising:
a deprotonation step of deprotonating an oligofuran compound in the presence of a deprotonating agent; and
a hydrosilylation step of allowing a deprotonated product of the oligofuran compound to react with a halohydrosilane compound,
wherein the oligofuran compound is a di- to 256-mer of a monofuran compound.

[2] The method of producing a dihydrosilyloligofuran compound according to [1], wherein the oligofuran compound is represented by the following Formula (A′-1):

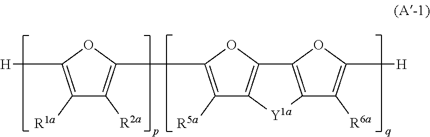

(wherein, R^{1a} and R^{2a} each independently represent a hydrogen atom, an optionally substituted hydrocarbon group having 1 to 20 carbon atoms, or an optionally substituted hydrocarbonoxy group having 1 to 20 carbon atoms: when R^{1a} and R^{2a} are each the optionally substituted hydrocarbon group having 1 to 20 carbon atoms, or the optionally substituted hydrocarbonoxy group having 1 to 20 carbon atoms, R^{1a} and R^{2a} are optionally bound to each other via a direct bond or a linking group to form a ring; R^{5a} and R^{6a} each independently represent a hydrogen atom, an optionally substituted hydrocarbon group having 1 to 20 carbon atoms, or an optionally substituted hydrocarbonoxy group having 1 to 20 carbon atoms; Y^{1a} represents —CH₂—, —CHR^{7a}—, —C(R^{7a})₂-, —PR^{7a}-, —S—, —O—, —Si(R^{7a})₂-, —NR^{7a}-, or —C═C—; R^{7a}s each independently represent a hydrocarbon group having 1 to 8 carbon atoms: p represents an integer of 0 to 256; q represents an integer of 0 to 128; and p+2q is an integer of 2 to 256).

[3] The method of producing a dihydrosilyloligofuran compound according to [1], wherein
the dihydrosilyloligofuran compound is a dihydrosilylbifuran compound, and
the oligofuran compound is a bifuran compound.

[4] The method of producing a dihydrosilyloligofuran compound according to [3], wherein the bifuran compound is represented by the following Formula (A-1) or (A-2):

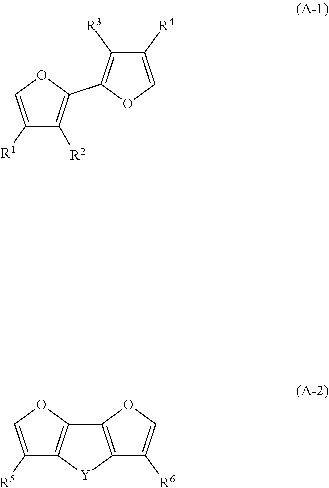

(wherein, R¹ to R⁴ each independently represent a hydrogen atom, an optionally substituted hydrocarbon group having 1 to 20 carbon atoms, or an optionally substituted hydrocarbonoxy group having 1 to 20 carbon atoms; when R¹ and R² are each the optionally substituted hydrocarbon group having 1 to 20 carbon atoms, or the optionally substituted hydrocarbonoxy group having 1 to 20 carbon atoms, R¹ and R² are optionally bound to each other via a direct bond or a linking group to form a ring; when R³ and R⁴ are each the optionally substituted hydrocarbon group having 1 to 20 carbon atoms, or the optionally substituted hydrocarbonoxy group having 1 to 20 carbon atoms, R³ and R⁴ are optionally bound to each other via a direct bond or a linking group to form a ring; R⁵ and R⁶ each independently represent a hydrogen atom, an optionally substituted hydrocarbon group having 1 to 20 carbon atoms, or an optionally substituted hydrocarbonoxy group having 1 to 20 carbon atoms: Y represents —CH₂—, —CHR⁷—, —C(R⁷)₂—, —PR⁷—, —S—, —O—, —Si(R⁷)₂—, —NR⁷—, or —C═C—; and R's each independently represent a hydrocarbon group having 1 to 8 carbon atoms).

[5] The method of producing a dihydrosilyloligofuran compound according to any one of [1] to [4], wherein the halohydrosilane compound is represented by the following Formula (B):

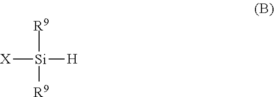

(wherein, R's each independently represent a hydrogen atom, an optionally substituted hydrocarbon group having 1 to 20 carbon atoms, or an optionally substituted hydrocarbonoxy group having 1 to 20 carbon atoms; and X represents a halogen atom).

[6] The method of producing a dihydrosilyloligofuran compound according to any one of [1] to [5], wherein the deprotonating agent is an organic alkali metal compound.

[7] A method of producing a dihydroxysilyloligofuran compound, the method comprising:
a dihydrosilyloligofuran compound production step of producing a dihydrosilyloligofuran compound by the method according to any one of [1] to [6]; and
a hydroxysilylation step of allowing the dihydrosilyloligofuran compound to react with water in the presence of a transition metal catalyst,
wherein the transition metal catalyst is at least one selected from the group consisting of a palladium catalyst, a rhodium catalyst, and a platinum catalyst.

[8] A reactive silyl group-containing oligofuran compound represented by the following Formula (C′-1) or (D′-1):

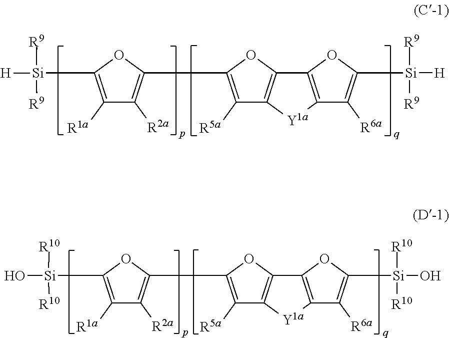

(wherein, R^{1a} and R^{2a} each independently represent a hydrogen atom, an optionally substituted hydrocarbon group having 1 to 20 carbon atoms, or an optionally substituted hydrocarbonoxy group having 1 to 20 carbon atoms: when R^{1a} and R^{2a} are each the optionally substituted hydrocarbon group having 1 to 20 carbon atoms, or the optionally substituted hydrocarbonoxy group having 1 to 20 carbon atoms, R^{1a} and R^{2a} are optionally bound to each other via a direct bond or a linking group to form a ring; R^{5a} and R^{6a} each independently represent a hydrogen atom, an optionally substituted hydrocarbon group having 1 to 20 carbon atoms, or an optionally substituted hydrocarbonoxy group having 1 to 20 carbon atoms: Y^{1a} represents —CH₂—, —CHR^{7a}-, —C(R^{7a})₂-, —PR^{7a}-, —S—, —O—, —Si(R^{7a})₂-, —NR^{7a}-, or —C═C—; R^{7a}s each independently represent a hydrocarbon group having 1 to 8 carbon atoms: p represents an integer of 0 to 256: q represents an integer of 0 to 128: p+2q is an integer of 2 to 256; R's each independently represent a hydrogen atom, an optionally substituted hydrocarbon group having 1 to 20 carbon atoms, or an optionally substituted hydrocarbonoxy group having 1 to 20 carbon atoms; and R¹⁰s each independently represent a hydroxy group, an optionally substituted hydrocarbon group having 1 to 20 carbon atoms, or an optionally substituted hydrocarbonoxy group having 1 to 20 carbon atoms).

[9] A reactive silyl group-containing bifuran compound represented by the following Formula (C-1), (C-2), (D-1), or (D-2):

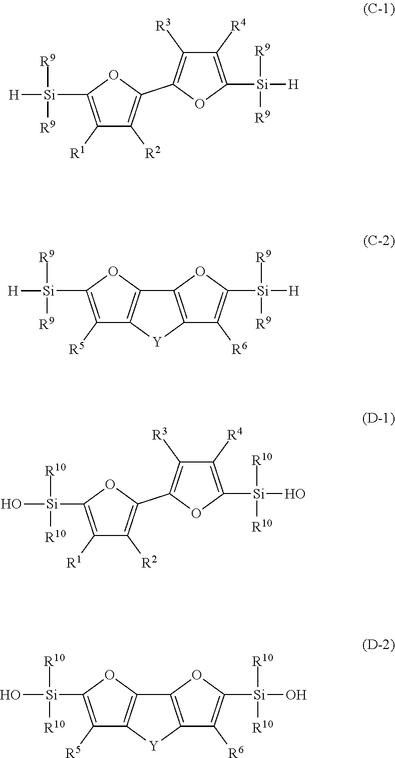

(wherein, R¹ to R⁴ each independently represent a hydrogen atom, an optionally substituted hydrocarbon group having 1 to 20 carbon atoms, or an optionally substituted hydrocarbonoxy group having 1 to 20 carbon atoms: when R¹ and R² are each the optionally substituted hydrocarbon group having 1 to 20 carbon atoms, or the optionally substituted hydrocarbonoxy group having 1 to 20 carbon atoms, R¹ and R² are optionally bound to each other via a direct bond or a linking group to form a ring; when R³ and R⁴ are each the optionally substituted hydrocarbon group having 1 to 20 carbon atoms, or the optionally substituted hydrocarbonoxy group having 1 to 20 carbon atoms, R³ and R⁴ are optionally bound to each other via a direct bond or a linking group to form a ring; R⁵ and R⁶ each independently represent a hydrogen atom, an optionally substituted hydrocarbon group having 1 to 20 carbon atoms, or an optionally substituted hydrocarbonoxy group having 1 to 20 carbon atoms: Y represents —CH₂—, —CHR⁷—, —C(R⁷)₂—, —PR⁷—, —S—, —O—, —Si(R⁷)₂—, —NR⁷—, or —C═C—; R⁷s each independently represent a hydrocarbon group having 1 to 8 carbon atoms: R's each independently represent a hydrogen atom, an optionally substituted hydrocarbon group having 1 to 20 carbon atoms, or an optionally substituted hydrocarbonoxy group having 1 to 20 carbon atoms; and R¹⁰s each independently represent a hydroxy group, an optionally substituted hydrocarbon group having 1 to 20 carbon atoms, or an optionally substituted hydrocarbonoxy group having 1 to 20 carbon atoms).

### Advantageous Effects of Invention

According to the present invention, a method by which an oligofuran compound containing a hydrosilyl group as a reactive silyl group can be produced with a high yield, as well as a novel oligofuran compound containing a hydrosilyl group as a reactive silyl group can be provided.

Further, according to the present invention, a method of producing an oligofuran compound containing a hydroxysilyl group from an oligofuran compound containing a hydrosilyl group, as well as a novel oligofuran compound containing a hydroxysilyl group as a reactive silyl group can be provided.

### BRIEF DESCRIPTION OF DRAWINGS

FIG. 1 shows a UV spectrum and a fluorescence spectrum of the dihydrosilylbifuran compound obtained in Example 1.

FIG. 2 shows a UV spectrum of the dihydrosilylmonofuran compound obtained in Comparative Example 1.

FIG. 3 shows a UV spectrum and a fluorescence spectrum of the dihydroxysilylbifuran compound obtained in Example 3.

FIG. 4 shows a UV spectrum and a fluorescence spectrum of the dihydrosilyl quarterfuran compound obtained in Example 4.

FIG. 5 shows the results of evaluating the aggregation-induced emission of the dihydrosilyl quarterfuran compound obtained in Example 4 (drawing substitute).

FIG. 6 shows the results of evaluating the aggregation-induced emission of the dihydrosilyl quarterfuran compound obtained in Example 4 (drawing substitute).

### DESCRIPTION OF EMBODIMENTS

The present invention will now be described in detail: however, the following descriptions of requirements are merely examples (representative examples) of the embodiments of the present invention, and the present invention is not limited thereto and can be carried out with various modifications within the scope of the gist of the present invention.

1. Method of Producing Dihydrosilyloligofuran Compound

The method of producing a dihydrosilyloligofuran compound according to a first embodiment of the present invention includes: the deprotonation step of deprotonating an oligofuran compound in the presence of a deprotonating agent; and the hydrosilylation step of allowing a deprotonated product of the oligofuran compound to react with a halohydrosilane compound. The method of producing a dihydrosilyloligofuran compound according to the present embodiment will now be described in more detail.

1-1. Deprotonation Step

The deprotonation step is the step of withdrawing a hydrogen (hereinafter, may be referred to as “α-position hydrogen”) bound to a carbon adjacent to the oxygen of the respective terminal furan ring of an oligofuran compound in the presence of a deprotonating agent. For example, when the oligofuran compound is a bifuran compound, the deprotonation step is the step of withdrawing a 5-position hydrogen and a 5′-position hydrogen of the bifuran compound.

### 1-1-1. Oligofuran Compound

The oligofuran compound in the present embodiment is a di- to 256-mer, preferably a di- to 16-mer, more preferably a di- to 8-mer, of a monofuran compound. The oligofuran compound is not particularly limited as long as it has an oligofuran skeleton in which carbons of 2 to 256 furan rings are linked with each other via direct bonds, and the furan rings on both terminals each have an α-position hydrogen, and the oligofuran compound can be selected as appropriate in accordance with the target dihydrosilyloligofuran compound. For example, a bifuran compound in which two furan rings are linked is not particularly limited as long as it has at least a 5-position hydrogen and a 5′-position hydrogen.

The oligofuran compound may be used singly, or in any combination of two or more kinds thereof at any ratio.

Examples of a preferred oligofuran compound include compounds represented by the following Formula (A′-1). It is noted here that the oligofuran compound is a known oligofuran compound, or one which can be easily produced by a known or equivalent production method. Examples of the known production method include those methods described in Japanese Unexamined Patent Application Publication No. 2020-002103, WO 2012/024171, and the like.

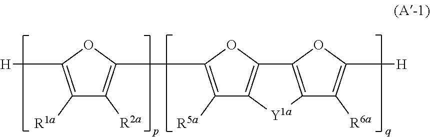

In Formula (A′-1), R^{1a} and R^{2a} each independently represent a hydrogen atom, an optionally substituted hydrocarbon group having 1 to 20 carbon atoms, or an optionally substituted hydrocarbonoxy group having 1 to 20 carbon atoms, and are preferably hydrogen atoms. When R^{1a} and R^{2a} are each an optionally substituted hydrocarbon group having 1 to 20 carbon atoms, or an optionally substituted hydrocarbonoxy group having 1 to 20 carbon atoms, R^{1a} and R^{2a} are optionally bound to each other via a direct bond or a linking group to form a ring.

It is noted here that the term “hydrocarbon” used herein encompasses aliphatic hydrocarbons and aromatic hydrocarbons. An aliphatic hydrocarbon is not limited to a linear hydrocarbon, and may have a branched structure, a carbon-carbon unsaturated bond, or a cyclic structure. An aromatic hydrocarbon may be of a monocyclic type, a polycyclic type, a fused-ring type, or a heterocyclic type.

Further, the numbers of carbon atoms that are indicated for a hydrocarbon group and a hydrocarbonoxy group include the number of carbon atoms of substituents and linking groups.

When the hydrocarbon groups represented by R^{1a} and R^{2a} are aliphatic hydrocarbon groups, the number of carbon atoms of these groups is usually 1 or more, but usually 20 or less, preferably 16 or less, more preferably 12, still more preferably 8 or less, yet still more preferably 4 or less. In other words, a preferred range of the number of carbon atoms of the aliphatic hydrocarbon groups represented by R^{1a} and R^{2a} is, for example, 1 to 16, 1 to 12, 1 to 8, or 1 to 4. Further, when the hydrocarbon groups represented by R^{1a} and R^{2a} are aromatic hydrocarbon groups, the number of carbon atoms of these groups is usually 3 or more, preferably 6 or more, but usually 20 or less, preferably 16 or less, more preferably 12 or less. In other words, a preferred range of the number of carbon atoms of the aromatic hydrocarbon groups represented by R^{1a} and R^{2a} is, for example, 3 to 16, 6 to 20, or 6 to 12.

Examples of an unsubstituted aliphatic hydrocarbon group include: linear or branched saturated aliphatic hydrocarbon groups, such as a methyl group, an ethyl group, an n-propyl group, an iso-propyl group, an n-butyl group, a sec-butyl group, an iso-butyl group, a tert-butyl group, an n-pentyl group, an iso-pentyl group, a neopentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, a 2-ethylhexyl group, an n-nonadecyl group, and an n-docosyl group: saturated aliphatic hydrocarbon groups having a cyclic structure, such as a cyclopropyl group, a cyclobutyl group, a cyclopentyl group, and a cyclohexyl group: unsaturated aliphatic hydrocarbon groups having a carbon-carbon double bond, such as a vinyl group, an allyl group, a 1-propenyl group, an iso-propenyl group, a 1-butenyl group, a 2-butenyl group, a 1,3-butadienyl group, a 2-methylallyl group, a 1-heptynyl group, a 1-hexenyl group, a 1-heptenyl group, a 1-octenyl group, and a 2-methyl-1-propenyl group; and unsaturated aliphatic hydrocarbon groups having a carbon-carbon triple bond, such as a propargyl group and a polyacetylene group.

In each of the unsaturated aliphatic hydrocarbon groups having a carbon-carbon double bond and the unsaturated aliphatic hydrocarbon groups having a carbon-carbon triple bond, the position of the carbon-carbon double bond and that of the carbon-carbon triple bond are not particularly limited, and may be 1-position, 2-position, 3-position, or any other position. The number of carbon-carbon double bonds and that of carbon-carbon triple bonds are also not particularly limited, and they are usually 1 or more but 10 or less, and may be 8 or less, or 5 or less.

Examples of an unsubstituted aromatic hydrocarbon group include a phenyl group, a 1-naphthyl group, a 2-naphthyl group, a 1-phenanthryl group, a 2-phenanthryl group, a 3-phenanthryl group, a 4-phenanthryl group, a 9-phenanthryl group, a 1-anthryl group, a 2-anthryl group, a 9-anthryl group, a 1-pyrenyl group, a 2-pyrenyl group, a 4-pyrenyl group, a 1-triphenylenyl group, a 2-triphenylenyl group, a 2-pyridyl group, a 3-pyridyl group, a 4-pyridyl group, a 2-pyrrolyl group, a 3-pyrrolyl group, a 2-thiophenylyl group, a 3-thiophenyl group, a 2-furyl group, and a 3-furyl group.

When the hydrocarbon groups represented by R^{1a} and R^{2a} have substituents, the substituents are not particularly limited as long as they do not inhibit the deprotonation and the hydrosilylation of the subsequent step, as well as the below-described hydroxysilylation, and may be selected as appropriate in accordance with the target dihydrosilyloligofuran compound or the below-described dihydroxysilyloligofuran compound. The positions and the number of the substituents are also not particularly limited.

Examples of the substituents include: a deuterium atom: alkyl groups having 1 to 16 carbon atoms, such as a methyl group, an ethyl group, an n-propyl group, an iso-propyl group, an n-butyl group, a sec-butyl group, an iso-butyl group, a tert-butyl group, an n-pentyl group, a neopentyl group, an n-hexyl group, an n-heptyl group, an n-octyl group, a 2-ethylhexyl group, an n-nonyl group, an n-decyl group, an n-undecyl group, an n-dodecyl group, an n-tridecyl group, an n-tetradecyl group, an n-pentadecyl group, and an n-hexadecyl group: cycloalkyl groups having 3 to 6 carbon atoms, such as a cyclopropyl group, a cyclobutyl group, a cyclopentyl group, and a cyclohexyl group: aromatic hydrocarbon groups having 6 to 10 carbon atoms, such as a phenyl group, a 1-naphthyl group, and a 2-naphthyl group: alkoxy groups having 1 to 4 carbon atoms, such as a methoxy group, an ethoxy group, an n-propyloxy group, an iso-propyloxy group, an n-butoxy group, a sec-butoxy group, an iso-butoxy group, and a tert-butoxy group: inert silyl groups, such as a trimethylsilyl group, a triethylsilyl group, a vinyldimethylsilyl group, and a triphenylsilyl group: a cyano group; a cyanate group; an isocyanate group: a nitro group; a nitroso group; and an oxo group.

The hydrocarbon groups in the hydrocarbonoxy groups represented by R^{1a} and R^{2a} have the same meaning as the hydrocarbon groups represented by R^{1a} and R^{2a}, and their preferred modes are also the same.

When R^{1a} are R^{2a} form a ring via a linking group, the linking group is not particularly limited, and examples thereof include —S—, —O—, —CO—, —COO—, —OCO—, —COS—, —SCO—, —CONR^{8a}-, —NR^{8a} CO—, —OCONR^{8a}-, —SO₂—, —C═C—, —C═N—, —N═C—, —N═N—, and-Si(R^{8a})₂-(wherein, R^{8a}s each independently represent a hydrocarbon group having 1 to 8 carbon atoms).

In Formula (A′-1), R^{5a} and R^{6a} each independently represent a hydrogen atom, an optionally substituted hydrocarbon group having 1 to 20 carbon atoms, or an optionally substituted hydrocarbonoxy group having 1 to 20 carbon atoms.

The optionally substituted hydrocarbon group having 1 to 20 carbon atoms and the optionally substituted hydrocarbonoxy group having 1 to 20 carbon atoms that are represented by R^{5a} and Rea have the same meaning as the optionally substituted hydrocarbon group having 1 to 20 carbon atoms and the optionally substituted hydrocarbonoxy group having 1 to 20 carbon atoms that are represented by R^{1a} and R^{2a} respectively, and their preferred modes are also the same.

In Formula (A′-1), Y^{1a} represents —CH₂—, —CHR^{7a}-, —C(R^{7a})₂-, —PR^{7a}—, —S—, —O—, —Si(R^{7a})₂-, —NR^{7a}-, or —C═C—. Further, R^{7a}s each independently represent a hydrocarbon group having 1 to 8 carbon atoms. Examples of the hydrocarbon group having 1 to 8 carbon atoms that is represented by R^{7a} include, among optionally substituted hydrocarbons having 1 to 20 carbon atoms that may be represented by R^{1a} and R^{2a}, those having 1 to 8 carbon atoms.

In Formula (A′-1), p is an integer of 0 to 256, preferably an integer of 0 to 16, more preferably an integer of 2 to 8, still more preferably 2, 4, or 8.

In Formula (A′-1), q is an integer of 0 to 128, preferably an integer of 0 to 8, more preferably 0, 2, or 4, still more preferably 0.

It is noted here that p+2q is an integer of 2 to 256, preferably an integer of 2 to 16, more preferably an integer of 2 to 8, still more preferably 2, 4, or 8. Further, from the standpoint of allowing the resulting oligosilane compound to exhibit aggregation-induced emission, p+2q is particularly preferably 4 or 8.

It is noted here that an arrangement of the structure existing in the number of p and the structure existing in the number of q in Formula (A′-1) is not particularly limited, and these structures may be randomly arranged or alternately arranged, or the same structures may be bound in series.

A bifuran compound, which is a particularly preferred mode among oligosilane compounds, will now be described in more detail. Examples of a preferred bifuran compound include compounds represented by the following Formula (A-1) or (A-2). It is noted here that the bifuran compound is a known bifuran compound, or one which can be easily produced by a known or equivalent production method. Examples of the known production method include the method described in Japanese Unexamined Patent Application Publication No. 2020-002103.

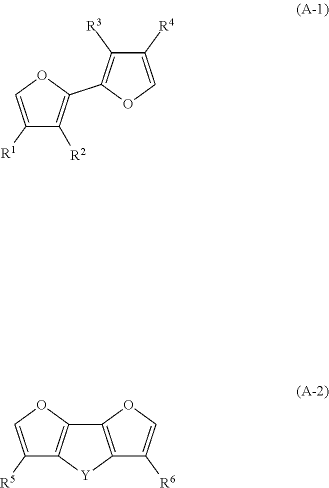

In Formula (A-1), R¹ to R⁴ each independently represent a hydrogen atom, an optionally substituted hydrocarbon group having 1 to 20 carbon atoms, or an optionally substituted hydrocarbonoxy group having 1 to 20 carbon atoms, and are preferably hydrogen atoms. When R¹ and R² are each an optionally substituted hydrocarbon group having 1 to 20 carbon atoms, or an optionally substituted hydrocarbonoxy group having 1 to 20 carbon atoms, R¹ and R² are optionally bound to each other via a direct bond or a linking group to form a ring. Further, when R³ and R⁴ are each an optionally substituted hydrocarbon group having 1 to 20 carbon atoms, or an optionally substituted hydrocarbonoxy group having 1 to 20 carbon atoms, R³ and R⁴ are optionally bound to each other via a direct bond or a linking group to form a ring.

The optionally substituted hydrocarbon group having 1 to 20 carbon atoms and the optionally substituted hydrocarbonoxy group having 1 to 20 carbon atoms that are represented by R¹ to R⁴ have the same meaning as the optionally substituted hydrocarbon group having 1 to 20 carbon atoms and the optionally substituted hydrocarbonoxy group having 1 to 20 carbon atoms that are represented by R^{1a} and R^{2a} in Formula (A′-1), respectively, and their preferred modes are also the same.

When R¹ and R² form a ring via a linking group and when R³ and R⁴ form a ring via a linking group, these linking groups have the same meaning as the linking group via which R^{1a} and R^{2a} in Formula (A′-1) form a ring.

In Formula (A-2), R⁵ and R⁶ each independently represent a hydrogen atom, an optionally substituted hydrocarbon group having 1 to 20 carbon atoms, or an optionally substituted hydrocarbonoxy group having 1 to 20 carbon atoms, and are preferably hydrogen atoms.

The optionally substituted hydrocarbon group having 1 to 20 carbon atoms and the optionally substituted hydrocarbonoxy group having 1 to 20 carbon atoms that are represented by R⁵ and R⁶ have the same meaning as the optionally substituted hydrocarbon group having 1 to 20 carbon atoms and the optionally substituted hydrocarbonoxy group having 1 to 20 carbon atoms that are represented by R^{1a} and R^{2a} in Formula (A′-1), respectively, and their preferred modes are also the same.

In Formula (A-2), Y represents —CH₂—, —CHR⁷—, —C(R⁷)₂—, —PR⁷—, —S—, —O—, —Si(R⁷)₂—, —NR⁷—, or —C═C—. Further, R's each independently represent a hydrocarbon group having 1 to 8 carbon atoms. Examples of the hydrocarbon group having 1 to 8 carbon atoms that is represented by R⁷ include, among optionally substituted hydrocarbons having 1 to 20 carbon atoms that may be represented by R^{1a} and R^{2a} in Formula (A′-1), those having 1 to 8 carbon atoms.

Specific examples of the bifuran compound represented by Formula (A-1) or (A-2) include the following.

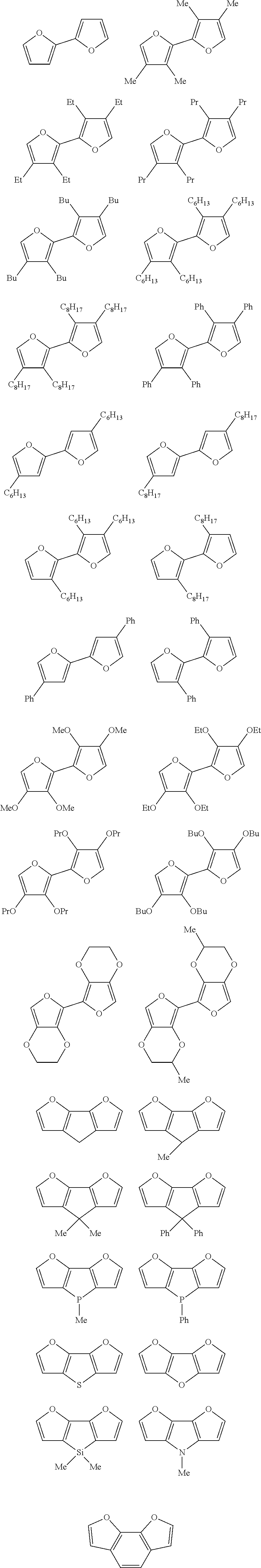

### 1-1-2. Deprotonating Agent

The deprotonating agent used in the deprotonation step is not particularly limited as long as it is capable of performing deprotonation by withdrawing an α-position hydrogen of a furan ring of an oligofuran compound, and the deprotonating agent is, for example, an organic alkali metal compound.

Examples of the organic alkali metal compound include organic lithium reagents, such as ethyl lithium, n-propyl lithium, isopropyl lithium, n-butyl lithium, sec-butyl lithium, tert-butyl lithium, and phenyl lithium. Thereamong, from the standpoint of the reactivity and the ease of handling, the organic alkali metal compound is preferably n-butyl lithium.

The deprotonating agent may be used singly, or in any combination of two or more kinds thereof at any ratio.

The amount of the deprotonating agent to be used in the deprotonation step is usually 2.0 equivalents or more, preferably 2.1 equivalents or more, more preferably 2.2 equivalents or more, but usually 10.0 equivalents or less, preferably 6.0 equivalents or less, more preferably 3.0 equivalents or less, with respect to the oligofuran compound that is a substrate. In other words, a preferred range of the amount of the deprotonating agent to be used with respect to the oligofuran compound is, for example, 2.0 equivalents to 6.0 equivalents, 2.1 equivalents to 10.0 equivalents, or 2.2 equivalents to 3.0 equivalents.

### 1-1-3. Deprotonation Accelerator

In the deprotonation step, a deprotonation accelerator may be used along with the deprotonating agent. The deprotonation accelerator can improve the basicity of the deprotonating agent to accelerate the deprotonation and, when the deprotonating agent is an organic alkali metal compound, a coordination compound that can be coordinated to an alkali metal atom may be used.

Examples of the coordination compound include: hexamethylphosphoramide (HMPA): dimethylpropylene urea (DMPU); tertiary amine compounds, such as N,N,N′,N′-tetramethylethylenediamine (TMEDA), trimethylamine, and triethylamine; and ether compounds, such as dibenzo-24-crown-8-ether, dicyclohexyl-24-crown-8-ether, 24-crown-8-ether, dibenzo-18-crown-6-ether, dicyclohexyl-18-crown-6-ether, 18-crown-6-ether, benzo-12-crown-4-ether, cyclohexyl-12-crown-4-ether, and 12-crown-4-ether. Thereamong, the coordination compound is preferably selected from tetramethylethylenediamine and 12-crown-4-ether.

The deprotonation accelerator may be used singly, or in any combination of two or more kinds thereof at any ratio.

The amount of the deprotonation accelerator to be used in the deprotonation step is not particularly limited, and can be determined as appropriate in accordance with its coordinating ability. For example, a specific amount of the deprotonation accelerator to be used is usually 0.5 equivalents or more, preferably 0.9 equivalents or more, but usually 5.0 equivalents or less, preferably 1.0 equivalent or less, with respect to the deprotonating agent. In other words, a preferred range of the amount of the deprotonation accelerator to be used with respect to the deprotonating agent is, for example, 0.5 equivalents to 1.0 equivalent, or 0.9 equivalents to 5.0 equivalents.

### 1-1-4. Solvent

The deprotonation step is usually performed in an anhydrous solvent so as to avoid deactivation of the deprotonating agent.

Examples of the solvent species include: aromatic hydrocarbon solvents, such as benzene, toluene, xylene, and mesitylene: aliphatic hydrocarbon solvents, such as hexane, heptane, cyclohexane, methylcyclohexane, octane, pentane, and cyclopentane; and ether solvents, such as dimethyl ether, diethyl ether, diisopropyl ether, dibutyl ether, tert-butyl methyl ether, cyclopentyl methyl ether, cyclohexyl methyl ether, anisole, 1,2-dioxane, 1,3-dioxane, 1,4-dioxane, and tetrahydrofuran (THF). Thereamong, the solvent is preferably an ether solvent, more preferably tetrahydrofuran.

The solvent may be used singly, or in any combination of two or more kinds thereof at any ratio.

### 1-1-5. Reaction Conditions

### (Operating Procedure)

The deprotonation step can be performed by, for example, the following procedure. First, the atmosphere inside a reactor equipped with a stirring means such as a magnetic stirrer or a stirring blade is purged with an inert atmosphere, and the oligofuran compound is then supplied into the reactor. Subsequently, the solvent and, as required, the deprotonation accelerator are supplied to the reactor to dissolve the oligofuran compound, and the resulting solution is cooled and adjusted to a low-temperature condition. Thereafter, while stirring the solution under the low-temperature condition, the deprotonating agent is added to the solution by dropwise addition or the like, and the resultant is heated as required to perform deprotonation. A reaction solution obtained in the deprotonation step, which contains a deprotonated product of the oligofuran compound, can be directly used in the hydrosilylation step.

### (Atmosphere Gas)

From the standpoint of inhibiting side reactions and suppressing deactivation of the deprotonating agent, the deprotonation step is performed in an inert atmosphere as described above. Examples of the inert atmosphere include nitrogen and argon. These inert gases may be used singly, or in any combination of two or more thereof at any ratio.

Further, the deprotonation step may be performed under normal pressure or increased pressure.

### (Reaction Temperature)

The reaction temperature in the deprotonation step varies depending on the type of the oligofuran compound, the type of the deprotonating agent, the presence or absence of the deprotonation accelerator, and the like; however, from the standpoint of controlling side reactions, it is preferred to, as described above, add the deprotonating agent to a solution containing the oligofuran compound under a low-temperature condition, and subsequently heat the resultant to allow the reaction to continue.

Specifically, the low-temperature condition is usually −100° C. or higher, preferably −90° C. or higher, more preferably −80° C. or higher, but usually 70° C. or lower, preferably 0° C. or lower, more preferably −20° C. or lower, still more preferably −50° C. or lower. In other words, a preferred low-temperature condition is a temperature range of, for example, −100° C. to 0° C., −90° C. to 70° C., −90° C. to −20° C., or −80° C. to −50° C. Further, the temperature reached during the heating performed after the addition of the deprotonating agent is usually 0° C. or higher, but usually 70° C. or lower, preferably 50° C. or lower, more preferably 40° C. or lower, still more preferably room temperature. In other words, a preferred range of the temperature reached during the heating performed after the addition of the deprotonating agent is, for example, 0° C. to 70° C., 0° C. to 50° C., 0° C. to 40° C., or room temperature.

It is noted here that the term “room temperature” used herein refers to a temperature of 15° C. to 35° C.

### (Reaction Time)

The reaction time of the deprotonation step is not particularly limited, and can be adjusted as appropriate in accordance with the reaction temperature, the reaction scale, and the like. Specifically, the reaction time after the addition of the deprotonating agent to the solution containing the oligofuran compound and the subsequent heating is usually 30 minutes or longer, preferably 1 hour or longer, more preferably 2 hours or longer, but usually 48 hours or shorter, preferably 24 hours or shorter, more preferably 12 hours or shorter, still more preferably 10 hours or shorter, yet still more preferably 6 hours or shorter, particularly preferably 5 hours or shorter, most preferably 3 hours or shorter. In other words, a preferred range of the reaction time is, for example, 30 minutes to 24 hours, 1 hour to 48 hours, 1 hour to 12 hours, 1 hour to 10 hours, 2 hours to 6 hours, 2 hours to 5 hours, or 2 hours to 3 hours.

### 1-2. Hydrosilylation Step

The hydrosilylation step is the step of allowing a deprotonated product of the oligofuran compound, which is obtained in the deprotonation step, to react with a halohydrosilane compound, and thereby introducing a hydrosilyl group into the oligofuran skeleton.

### 1-2-1. Halohydrosilane Compound

The halohydrosilane compound used in the hydrosilylation step is not particularly limited as long as it has a hydrosilyl group and a halosilyl group, and can be selected as appropriate in accordance with the target dihydrosilyloligofuran compound.

The halohydrosilane compound may be used singly, or in any combination of two or more kinds thereof at any ratio.

Examples of a preferred halohydrosilane compound include compounds represented by the following Formula (B). It is noted here that the halohydrosilane compound is a known halohydrosilane compound, or one which can be easily produced by a known or equivalent production method.

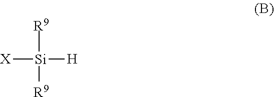

In Formula (B), R's each independently represent a hydrogen atom, an optionally substituted hydrocarbon group having 1 to 20 carbon atoms, or an optionally substituted hydrocarbonoxy group having 1 to 20 carbon atoms. Particularly, Ros are each preferably an unsubstituted hydrocarbon group having 1 to 20 carbon atoms.

The hydrocarbon group represented by each R⁹ and the hydrocarbon group in the hydrocarbonoxy group represented by each R⁹ have the same meaning as the hydrocarbon groups represented by R¹ to R⁴, and their preferred modes are also the same. Further, it is also preferred that two R's be the same group.

In Formula (B), X represents a halogen atom. Examples of the halogen atom include a fluorine atom, a chlorine atom, a bromine atom, and an iodine atom. X is preferably a chlorine atom, a bromine atom, or an iodine atom, more preferably a chlorine atom or a bromine atom, still more preferably a chlorine atom.

Specific examples of the halohydrosilane compound represented by Formula (B) include chlorodimethylsilane, chlorodiethylsilane, chloroethylmethylsilane, chlorodipropylsilane, chlorodibutylsilane, chlorodipentylsilane, chlorodihexylsilane, chlorodioctylsilane, chlorodiphenylsilane, chlorodinaphthylsilane, bromodimethylsilane, bromodiethylsilane, bromoethylmethylsilane, bromodipropylsilane, bromodibutylsilane, bromodipentylsilane, bromodihexylsilane, bromodioctylsilane, bromodiphenylsilane, bromodinaphthylsilane, iododimethylsilane, iododiethylsilane, iodoethylmethylsilane, iododipropylsilane, iododibutylsilane, iododipentylsilane, iododihexylsilane, iododioctylsilane, iododiphenylsilane, and iododinaphthylsilane.

### 1-2-2. Solvent

The hydrosilylation step is performed by adding the halohydrosilane compound to the reaction solution obtained in the deprotonation step. Accordingly, the hydrosilylation step is performed in the solvent used in the deprotonation step.

It is noted here, however, that the solvent used in the deprotonation step, which is described above in the section “1-1-4. Solvent”, may be added to the reaction system in the hydrosilylation step. In this case, only the solvent may be added to the reaction system, or a solution obtained by dissolving the halohydrosilane compound in the solvent may be added to the reaction solution obtained in the deprotonation step.

### 1-2-3. Reaction Conditions

### (Operating Procedure)

The hydrosilylation step can be performed by, for example, the following procedure. First, a solution containing the deprotonated product of the oligofuran compound is cooled and adjusted to a low-temperature condition. Subsequently, while stirring this solution in an inert atmosphere under the low-temperature condition, the halohydrosilane compound is added to the resulting solution, which is then heated as required to allow a hydrosilylation reaction to proceed.

### (Atmosphere Gas)

From the standpoint of inhibiting protonation of the deprotonated product of the oligofuran compound and other side reactions, the hydrosilylation step is preferably performed in an inert atmosphere. Examples of the inert atmosphere include nitrogen and argon. These inert gases may be used singly, or in any combination of two or more thereof at any ratio.

In terms of working efficiency, it is preferred to perform the hydrosilylation step by supplying the halohydrosilane compound to the reactor in which the deprotonation step has been performed and, accordingly, it is also preferred to use the inert atmosphere, in which the deprotonation step has been performed, directly for the hydrosilylation step.

Further, the hydrosilylation step may be performed under normal pressure or increased pressure.

### (Reaction Temperature)

The reaction temperature in the hydrosilylation step varies depending on the type of the oligofuran compound, the type of the halohydrosilane compound, the reaction scale, and the like; however, from the standpoint of controlling side reactions, it is preferred to, as described above, add the halohydrosilane compound to a solution containing the oligofuran compound under a low-temperature condition, and subsequently heat the resultant to allow the reaction to continue.

Specifically, the low-temperature condition is usually −100° C. or higher, preferably −90° C. or higher, more preferably −80° C. or higher, but usually 70° C. or lower, preferably 0° C. or lower, more preferably −20° C. or lower, still more preferably −50° C. or lower. In other words, a preferred low-temperature condition is a temperature range of, for example, −100° C. to 0° C., −90° C. to −70° C., −90° C. to −20° C., or −80° C. to −50° C. Further, the temperature reached during the heating performed after the addition of the halohydrosilane compound is usually 0° C. or higher, but usually 70° C. or lower, preferably 50° C. or lower, more preferably 40° C. or lower, still more preferably room temperature. In other words, a preferred range of the temperature reached during the heating performed after the addition of the halohydrosilane compound is, for example, 0° C. to 70° C., 0° C. to 50° C., 0° C. to 40° C., or room temperature.

### (Reaction Time)

The reaction time of the hydrosilylation step is not particularly limited, and can be adjusted as appropriate in accordance with the reaction temperature, the reaction scale, and the like. Specifically, the reaction time after the addition of the halohydrosilane compound to the solution containing the deprotonated product of the oligofuran compound and the subsequent heating is usually 30 minutes or longer, preferably 1 hour or longer, more preferably 2 hours or longer, but usually 48 hours or shorter, preferably 24 hours or shorter, more preferably 12 hours or shorter, still more preferably 6 hours or shorter. In other words, a preferred range of the reaction time is, for example, 30 minutes to 24 hours, 1 hour to 48 hours, 1 hour to 12 hours, or 2 hours to 6 hours.

### 1-3. Other Steps

The method of producing a dihydrosilyloligofuran compound according to the present embodiment may include an optional step in addition to the deprotonation step and the hydrosilylation step. Examples of the optional step include the protection step, the deprotection step, and the purification step for improving the purity of the resulting dihydrosilyloligofuran compound.

When one or both of the oligofuran compound that is a reaction substrate and the halohydrosilane compound contain a group having a reactivity for the deprotonation reaction and/or the hydrosilylation reaction, or a group that inhibits these reactions, the protection step is performed for the purpose of protecting such a group prior to the pertinent reaction. Further, the deprotection step is performed after the pertinent reaction is completed and the protection is no longer necessary. As a protecting group, any known protecting group can be used, and the protection and the deprotection can be performed by any known or equivalent method.

For the purification step, a purification method that is normally performed in the field of organic synthesis, such as filtration, adsorption, column chromatography, distillation, or sublimation, can be employed. Particularly, when a dihydrosilyloligofuran compound is obtained in a quantitative manner, purification thereof can be easily performed by distillation, sublimation, or the like.

### 1-4. Dihydrosilyloligofuran Compound

A dihydrosilyloligofuran compound produced by the production method according to the present embodiment is not particularly limited as long as it is obtained through the deprotonation step and the hydrosilylation step: however, the dihydrosilyloligofuran compound is preferably a dihydrosilyloligofuran compound represented by the following Formula (C′-1) that is obtained using a compound represented by Formula (A′-1) as the oligofuran compound and a compound represented by Formula (B) as the halohydrosilane compound, or a dihydrosilylbifuran compound represented by the following Formula (C-1) or (C-2) that is obtained using a bifuran compound represented by Formula (A-1) or (A-2) as the oligofuran compound and a compound represented by Formula (B) as the halohydrosilane compound.

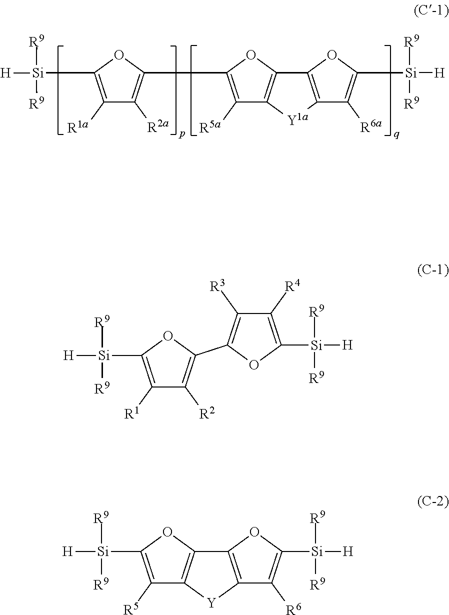

In Formula (C′-1), R^{1a}, R^{2a}, R^{5a}, R^{6a}, Y^{1a}, p, and q have the same meaning as R^{1a}, R^{2a}, R^{5a}, R^{6a}, Y^{1a}, p, and q in Formula (A′-1), respectively, and their preferred modes are also the same.

In Formula (C-1), R¹ to R⁴ have the same meaning as R¹ to R⁴ in Formula (A-1), respectively, and their preferred modes are also the same.

In Formula (C-2), R⁵, R⁶, and Y have the same meaning as R⁵, R⁶, and Y in Formula (A-2), respectively, and their preferred modes are also the same.

In Formulae (C′-1), (C-1), and (C-2), R⁹ has the same meaning as R⁹ in Formula (B), and their preferred modes are also the same.

It is noted here that an arrangement of the structure existing in the number of p and the structure existing in the number of q in Formula (C′-1) is not particularly limited, and these structures may be randomly arranged or alternately arranged, or the same structures may be bound in series.

### 2. Method of Producing Dihydroxysilyloligofuran Compound

The method of producing a dihydroxysilyloligofuran compound according to a second embodiment of the present invention includes: the dihydrosilyloligofuran compound production step of producing a dihydrosilyloligofuran compound by the production method according to the first embodiment of the present invention; and the hydroxysilylation step of allowing the dihydrosilyloligofuran compound to react with water in the presence of at least one transition metal catalyst selected from the group consisting of a palladium catalyst, a rhodium catalyst, and a platinum catalyst. The hydroxysilylation step and other steps that may be included in the production method of the present embodiment will now be described in detail.

### 2-1. Hydroxysilylation Step

The hydroxysilylation step is the step of allowing the dihydrosilyloligofuran compound produced by the dihydrosilyloligofuran compound production step to react with water in the presence of a transition metal catalyst.

### 2-1-1. Transition Metal Catalyst

The transition metal catalyst used in the hydroxysilylation step is not particularly limited as long as it is at least one selected from the group consisting of a palladium catalyst, a rhodium catalyst, and a platinum catalyst, and can facilitate a reaction of converting an Si—H group into an Si—OH group.

Examples of the palladium catalyst include palladium-on-carbon (Pd/C) in which zero-valent palladium is dispersed and/or supported on activated carbon, palladium chloride, and palladium dibenzylideneacetone. Thereamong, the palladium catalyst is preferably Pd/C since Pd/C has a high catalytic activity and can be easily separated and removed by filtration or the like after the reaction.

Examples of the rhodium catalyst include a catalyst in which rhodium is supported on aluminum oxyhydroxide (Rh/aluminum oxyhydroxide).

Further, examples of the platinum catalyst include platinum-on-carbon (Pt/C) in which platinum is supported on activated carbon.

The amount of the transition metal catalyst to be used in the hydroxysilylation step may be selected as appropriate in accordance with the type of the dihydrosilyloligofuran compound, the reaction temperature, and the like. Specifically, the amount of the transition metal catalyst to be used is usually 0.05% by mole or more, preferably 0.10% by mole or more, more preferably 0.20% by mole or more, but usually 5.00% by mole or less, preferably 2.00% by mole or less, more preferably 1.00% by mole or less, still more preferably 0.50% by mole or less, with respect to the Si—H groups of the dihydrosilyloligofuran compound. In other words, a preferred range of the amount of the transition metal catalyst to be used with respect to the Si—H groups of the dihydrosilyloligofuran compound is, for example, 0.05% by mole to 2.00% by mole, 0.10% by mole to 5.00% by mole, 0.10% by mole to 1.00% by mole, or 0.20% by mole to 0.50% by mole. It is noted here that the above-described amount (% by mole) of the transition metal catalyst to be used refers to the amount of use in terms of transition metal.

### 2-1-2. Water

The water in the hydroxysilylation step is not particularly limited, and can be selected as appropriate from pure water, ion-exchanged water, tap water, distilled water, and the like.

The amount of the water to be used in the hydroxysilylation step may be selected as appropriate in accordance with the catalyst species, the reaction temperature, and the like. Specifically, the amount of the water to be used is usually 1.0 equivalent or more, preferably 1.5 equivalents or more, more preferably 2.0 equivalents or more, but usually 10.0 equivalents or less, preferably 8.0 equivalents or less, more preferably 6.0 equivalents or less, with respect to the Si—H groups of the dihydrosilyloligofuran compound. In other words, a preferred range of the amount of the water to be used with respect to the Si—H groups of the dihydrosilyloligofuran compound is, for example, 1.0 equivalent to 8.0 equivalents, 1.5 equivalents to 10.0 equivalents, or 2.0 equivalents to 6.0 equivalents.

### 2-1-3. Solvent

In the hydroxysilylation step, it is preferred to use a solvent other than water. As this solvent, any of the solvents exemplified above in the section “1-1-4. Solvent” can be used, and the solvent is preferably an ether solvent, more preferably tetrahydrofuran.

### 2-1-4. Reaction Conditions

### (Operating Procedure)

The hydroxysilylation step can be performed by mixing the dihydrosilyloligofuran compound, the catalyst, the water and, as required, the solvent and the like, and stirring the resulting mixture at a desired temperature.

### (Atmosphere Gas)

The hydroxysilylation step may be performed in an inert atmosphere or an air atmosphere: however, from the standpoint of simplifying the operation, the hydroxysilylation step is preferably performed in an air atmosphere. Examples of the inert atmosphere include nitrogen and argon. These inert gases may be used singly, or in any combination of two or more thereof at any ratio.

Further, the hydroxysilylation step may be performed under normal pressure or increased pressure.

### (Reaction Temperature)

The reaction temperature in the hydroxysilylation step varies depending on the type of the dihydrosilyloligofuran compound, the reaction scale, and the like: however, it is usually 0° C. or higher, preferably 10° C. or higher, more preferably 15° C. or higher, but usually 100° C. or lower, preferably 50° C. or lower, more preferably 35° C. or lower. In other words, a preferred range of the reaction temperature is, for example, 0° C. to 50° C., 10° C. to 100° C., or 15° C. to 35° C.

### (Reaction Time)

The reaction time of the hydroxysilylation step is not particularly limited, and can be adjusted as appropriate in accordance with the reaction temperature, the reaction scale, and the like. Specifically, the reaction time after the dihydrosilyloligofuran compound, the catalyst, the water and, as required, the solvent and the like are mixed and a desired temperature is reached is usually 30 minutes or longer, preferably 1 hour or longer, more preferably 2 hours or longer, but usually 48 hours or shorter, preferably 24 hours or shorter, more preferably 12 hours or shorter, still more preferably 6 hours or shorter. In other words, a preferred range of the reaction time is, for example, 30 minutes to 24 hours, 1 hour to 48 hours, 1 hour to 12 hours, or 2 hours to 6 hours.

### 2-2. Other Steps

In the production of a dihydroxysilyloligofuran compound, other steps may be performed as well. Examples of the other steps include the purification step for improving the purity of the resulting dihydroxysilyloligofuran compound. For the purification step, a purification method that is normally performed in the field of organic synthesis, such as filtration, adsorption, column chromatography, distillation, or sublimation, can be employed.

### 2-3. Dihydroxysilyloligofuran Compound

A dihydroxysilyloligofuran compound produced by the production method according to the present embodiment is not particularly limited as long as it is obtained by hydroxysilylation of a dihydrosilyloligofuran compound produced by the production method according to the first embodiment of the present invention. The dihydroxysilyloligofuran compound produced by the production method according to the present embodiment is preferably a dihydroxysilyloligofuran compound represented by the following Formula (D′-1) that is obtained by converting the Si—H groups of a dihydrosilyloligofuran compound represented by Formula (C′-1) into Si—OH groups, or a dihydroxysilylbifuran compound represented by the following Formula (D-1) or (D-2) that is obtained by converting the Si—H groups of a dihydrosilylbifuran compound represented by Formula (C-1) or (C-2) into Si—OH groups.

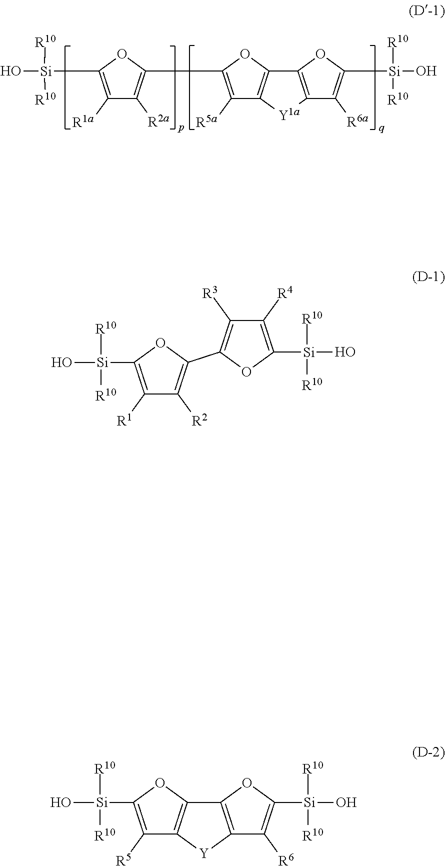

In Formula (D′-1), R^{1a}, R^{2a}, R^{5a}, R^{6a}, Y^{1a}, p, and q have the same meaning as R^{1a}, R^{2a}, R^{5a}, R^{6a}, Y^{1a}, p, and q in Formula (C′-1), respectively, and their preferred modes are also the same.

In Formula (D-1), R¹ to R⁴ have the same meaning as R¹ to R⁴ in Formula (C-1), respectively, and their preferred modes are also the same.

In Formula (D-2), R⁵, R⁶, and Y have the same meaning as R⁵, R⁶, and Y in Formula (C-2), respectively, and their preferred modes are also the same.

In Formulae (D′-1), (D-1), and (D-2), R¹⁰s each represent a hydroxy group, an optionally substituted hydrocarbon group having 1 to 20 carbon atoms, or an optionally substituted hydrocarbonoxy group having 1 to 20 carbon atoms. In Formulae (D′-1), (D-1), and (D-2), R¹⁰s are groups corresponding to R's in Formulae (C′-1), (C-1), and (C-2), respectively. Accordingly, for example, when R's are hydrogen atoms in Formulae (C′-1), (C-1), and (C-2), R¹⁰s corresponding to these R's are hydroxy groups.

It is noted here that an arrangement of the structure existing in the number of p and the structure existing in the number of q in Formula (D′-1) is not particularly limited, and these structures may be randomly arranged or alternately arranged, or the same structures may be bound in series.

### 3. Use of Dihydrosilyloligofuran Compound and Dihydroxysilyloligofuran Compound

A dihydrosilyloligofuran compound obtained by the production method according to the first embodiment of the present invention and a dihydroxysilyloligofuran compound obtained by the production method according to the second embodiment of the present invention contain hydrosilyl groups and hydroxysilyl groups, respectively. Therefore, these compounds exhibit activity for organic synthesis reactions, such as a hydrosilylation reaction and a dehydration-condensation reaction, and therefore can be developed into organic semiconductor materials and the like in which a π-conjugated system or a σ-π-conjugated system is expanded. Particularly, as demonstrated in the below-described Examples, among dihydrosilyloligofuran compounds and dihydroxysilyloligofuran compounds, those having a skeleton in which four or more furan rings are linked together are also expected to be developed into light emitting materials, such as organic light-emitting device materials, as well as coating materials.

### EXAMPLES

The present invention will now be described more concretely by way of Examples; however, modifications can be made as appropriate without departing from the spirit of the present invention. Accordingly, the scope of the present invention should not be construed as being limited to the specific examples described below.

The following instruments were used for various evaluations performed in Examples.

### (NMR Measurement)

Instrument: NMR spectrometer “JNM-ECS400” or “JNM-ECA600” (manufactured by JEOL Ltd.)
Solvent: deuterated chloroform containing tetramethylsilane as an internal standard

### (IR Measurement)

Instrument: Fourier transform infrared spectrophotometer “FT/IR-4700” (manufactured by JASCO Corporation)

This spectrophotometer was fitted with ATR PRO ONE (manufactured by JASCO Corporation) and a diamond prism, and the measurement was performed by a single-reflection attenuated total reflectance (ATR) method.

### (Measurement of UV Spectrum)

Instrument: UV-visible spectrophotometer “UV, U-3000” (manufactured by Hitachi, Ltd.)

### (Measurement of Fluorescence Spectrum)

Spectrofluorometer “F-4500” (manufactured by Hitachi, Ltd.)

### (Calculation of HOMO, LUMO, and Maximum Absorption Wavelength)

Quantum-chemical calculation program: Gaussian DFT (B3LYP/6-311++G (d,p))

### Example 1

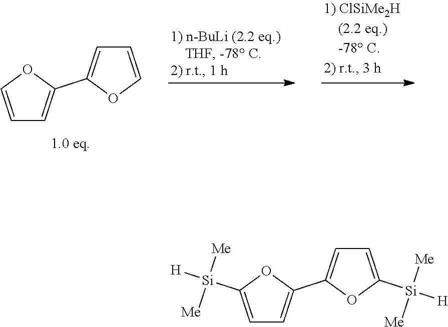 [SMILES: c1coc(-c2ccco2)c1 ; C[SiH](C)c1ccc(-c2ccc([SiH](C)C)o2)o1]

In a nitrogen-purged 50-mL Schlenk flask, 2,2′-bifuran (0.62 g, 4.6 mmol) and anhydrous tetrahydrofuran (30 mL) were added and stirred at −78° C. for 30 minutes. To the thus obtained 2,2′-bifuran solution, a hexane solution of n-butyl lithium (2.69 M, 3.8 mL, 10 mmol) was added dropwise, followed by 30-minute stirring at −78° C. Subsequently, the resulting reaction solution was heated to room temperature and stirred for 1 hour to perform deprotonation.

Then, the reaction solution obtained by the deprotonation was cooled to −78° C. with stirring, and chlorodimethylsilane (0.87 mL, 10 mmol) was added thereto dropwise. Thereafter, this reaction solution was heated to room temperature and stirred for 3 hours to perform silylation.

Water and hexane were added to the resulting reaction mixture to extract an organic layer. The thus obtained extract was washed with saturated saline and dried over anhydrous sodium sulfate, after which the solvents were removed by distillation under reduced pressure to obtain a red solid as a crude product. This crude product was purified by Kugelrohr distillation, whereby 5,5′-bis(dimethylsilyl)-2,2′-bifuran was obtained as a white solid (0.77 g, yield: 67%).
¹H NMR (400 MHz, CDCl₃, 293K): δ 6.73 (d, J=3.2 Hz, 2H), 86.60 (d, J=3.2 Hz, 2H), 84.45 (m, J=4.0 Hz, 2H), 80.37 (d, J=4.0 Hz, 12H) ppm
¹³C-NMR (150 MHz, CDCl₃): δ 157, 151, 123, 106,-4.52 ppm
²⁹Si NMR (119 MHz, CDCl₃): δ -28 ppm
Melting point: 46.3° C. to 48.1° C.
IR: 2,150 cm⁻¹ (Si—H)

### Example 2

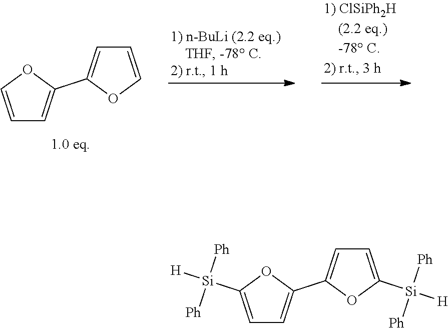 [SMILES: c1coc(-c2ccco2)c1 ; c1ccc([SiH](c2ccccc2)c2ccc(-c3ccc([SiH](c4ccccc4)c4ccccc4)o3)o2)cc1]

5,5′-bis(diphenylsilyl)-2,2′-bifuran was obtained in the same manner as in Example 1, except that chlorodiphenylsilane (1.01 g, 10 mmol) was used in place of chlorodimethylsilane. The yield of this dihydrosilylbifuran compound was calculated to be 88% based on 1H-NMR measurement using N,N′-dimethylformamide as an internal standard substance.

### Comparative Example 1

2,5-bis(diphenylsilyl) furan was obtained in the same manner as in Example 1, except that furan (0.31 g, 4.6 mmol) was used in place of 2,2′-bifuran.

### Example 3

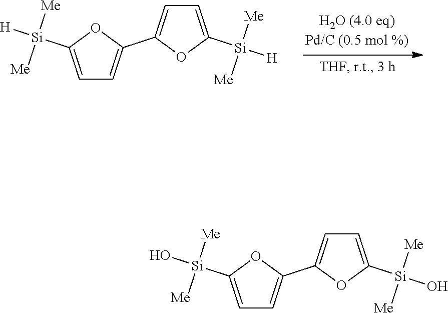 [SMILES: C[SiH](C)c1ccc(-c2ccc([SiH](C)C)o2)o1 ; C[Si](C)(O)c1ccc(-c2ccc([Si](C)(C)O)o2)o1]

In air atmosphere, 5,5′-bis(dimethylsilyl)-2,2′-bifuran (0.20 g, 0.80 mmol) obtained in Example 1, anhydrous tetrahydrofuran (3.0 mL), water (56 μL, 3.2 mmol), and Pd/C (Pd 5%, 8.5 mg, 4.0 μmol (in terms of Pd)) were added to a Schlenk flask (50 mL), and these materials were stirred at room temperature for 3 hours. Subsequently, Pd/C was removed from the resulting reaction mixture by celite filtration, and the solvents were removed by distillation under reduced pressure to obtain a brown solid. This brown solid was dissolved in ethyl acetate and then purified by column chromatography using hexane:ethyl acetate (2:1) as a developing solvent, whereby 5,5′-bis(dimethylhydroxysilyl)-2,2′-bifuran was obtained as a white solid (89 mg, yield: 39%).

### Example 4

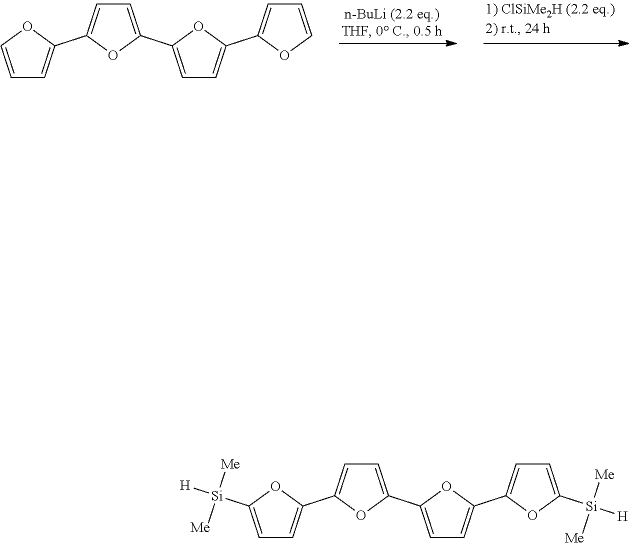 [SMILES: c1coc(-c2ccc(-c3ccc(-c4ccco4)o3)o2)c1 ; C[SiH](C)c1ccc(-c2ccc(-c3ccc(-c4ccc([SiH](C)C)o4)o3)o2)o1]

In a nitrogen-purged 50-mL Schlenk flask, 2,2′-quarterfuran (0.11 g, 0.42 mmol) and anhydrous tetrahydrofuran (20 mL) were added and stirred at 0° C. for 30 minutes. To the thus obtained 2,2′-quarterfuran solution, a hexane solution of n-butyl lithium (2.64 M, 0.40 mL, 1.1 mmol) was added dropwise, and the resultant was stirred at 0° C. for 30 minutes to perform deprotonation.

Subsequently, chlorodimethylsilane (0.13 mL, 1.2 mmol) was added dropwise to the reaction solution obtained by the deprotonation. Thereafter, this reaction solution was heated to room temperature and stirred for 24 hours to perform silylation.

To the resulting reaction mixture, an excess amount of saturated aqueous ammonium chloride solution was added, and an organic layer was extracted with ethyl acetate. The thus obtained extract was washed with saturated saline and dried over anhydrous sodium sulfate, after which the solvents were removed by distillation under reduced pressure to obtain a brown solid as a crude product. This crude product was recrystallized from ethanol, whereby 5,5′-bis(dimethylsilyl)-quarterfuran was obtained (0.080 g, yield: 71%). The thus obtained 5,5′-bis(dimethylsilyl)-quarterfuran was in the form of a brown solid exhibiting a metallic luster that is not seen in bifuran compounds.

¹H NMR (400 MHz, CDCl₃, 293K): δ 6.75 (d, J=3.2 Hz, 2H), 86.70 (d, J=3.7 Hz, 2H), 86.68 (d, J=3.7 Hz, 2H), 86.64 (d, J=3.2 Hz, 2H), 84.62 (m, J=4.0 Hz, 2H), 80.39 (d, J=4.0 Hz, 12H) ppm
¹³C-NMR (150 MHz, CDCl₃): δ 157.3, 150.6, 146.3, 145.6, 122.8, 107.6, 107.4, 105.8,-4.4 ppm
²⁹Si NMR (119 MHz, CDCl₃): δ -28 ppm
   [Evaluation of Reactivity I: Hydrosilylation Reaction between Dihydrosilylbifuran Compound and Alkene]

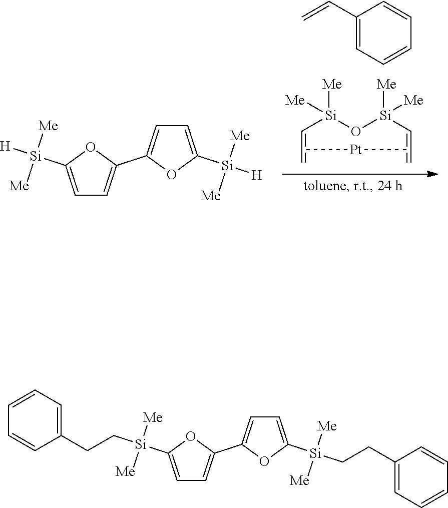

In a nitrogen-purged Schlenk flask (30 mL), a 1,3-divinyl-1,1,3,3-tetramethyldisiloxane-platinum (0) complex solution (1.8 μL, 4.8 μmol), toluene (0.25 mL), 5,5′-bis(dimethylsilyl)-2,2′-bifuran (0.18 g, 0.72 mmol) obtained in Example 1, and styrene (0.18 mL, 1.6 mmol) were added and stirred at room temperature for 24 hours. After reaction, the solvents were removed from the resulting reaction mixture to obtain a crude product. This crude product was purified by column chromatography using hexane:ethyl acetate (50:1) as a developing solvent, whereby 5,5′-bis(phenethyldimethylsilyl)-2,2′-bifuran was obtained as a granular white solid (0.11 g, yield: 30%).

From the above, it was confirmed that a dihydrosilylbifuran compound exhibits an activity for a hydrosilylation reaction with an alkene, and a σ-π-conjugated system can be expanded by hydrosilylation.

[Evaluation of Reactivity II: Hydrosilylation Reaction between Dihydrosilylbifuran Compound and Alkyne]

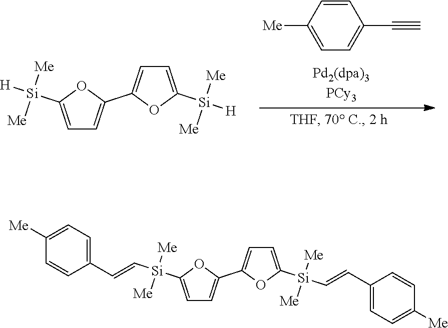

In a nitrogen-purged 20-mL two-necked round-bottom flask, Pd₂(dpa)₃ (2.2 mg, 2.4 μmol), PCy₃ (10 μL, 5.0 μmol), and anhydrous tetrahydrofuran (0.12 mL) were added and stirred at room temperature to synthesize Pd-PCy₃. Subsequently, in a 30-mL nitrogen-purged Schlenk flask, 5,5′-bis(dimethylsilyl)-2,2′-bifuran (50 mg, 0.20 mmol) obtained in Example 1, 4-ethynyltoluene (51 μL, 0.40 mmol), anhydrous tetrahydrofuran (32 μL), and Pd-PCy₃ (0.12 mL) were added and stirred at 70° C. for 2 hours. After reaction, the solvents were removed from the resulting reaction mixture to obtain a crude product. This crude product was purified by column chromatography using hexane:ethyl acetate (50:1) as a developing solvent, whereby 5,5′-bis(4-methylstyryldimethylsilyl)-2,2′-bifuran was obtained as a viscous brown liquid (68 mg, yield: 71%).

From the above, it was confirmed that a dihydrosilylbifuran compound exhibits an activity for a hydrosilylation reaction with an alkyne, and a π-conjugated system can be expanded by hydrosilylation.

### [Evaluation of Optical Properties]

5,5′-bis(dimethylsilyl)-2,2′-bifuran obtained in Example 1 and 5,5′-bis(dimethylhydroxysilyl)-2,2′-bifuran obtained in Example 3 were each dissolved in acetonitrile to prepare solutions having a concentration of 10 μM as samples for measurement of UV spectrum and fluorescence spectrum. In addition, 5,5′-bis(dimethylsilyl)-quarterfuran obtained in Example 4 was dissolved in chloroform to prepare a solution having a concentration of 10 μM as a sample for measurement of UV spectrum, as well as a solution having a concentration of 1 μM as a sample for measurement of fluorescence spectrum. For comparison, a sample solution having a concentration of 10 μM was prepared in the same manner for each of 2,5-bis(dimethylsilyl) furan obtained in Comparative Example 1 and 2,2′-bifuran.

Using the thus prepared samples, UV spectrum and fluorescence spectrum were measured.

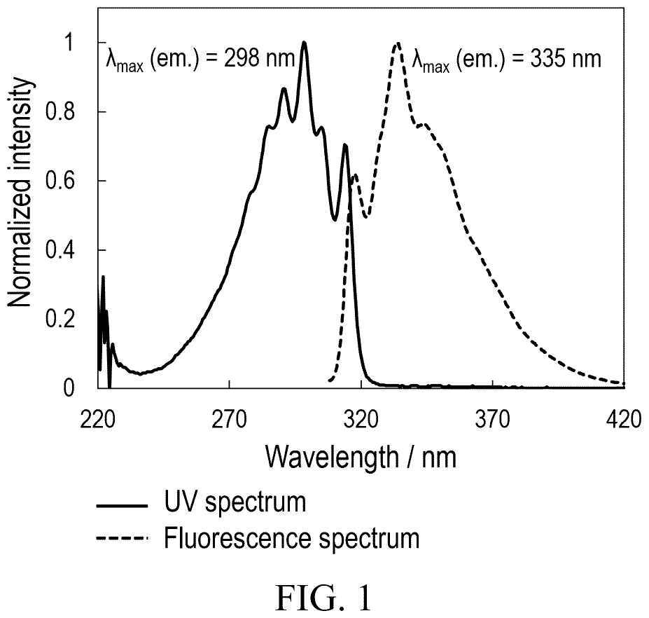

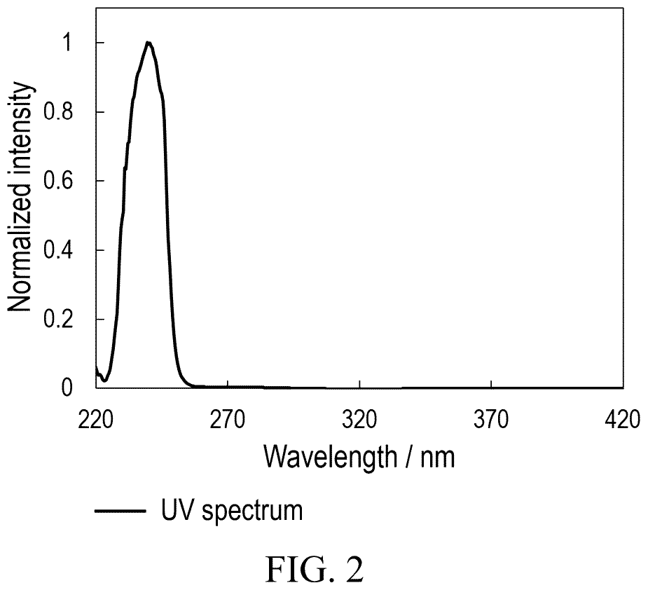

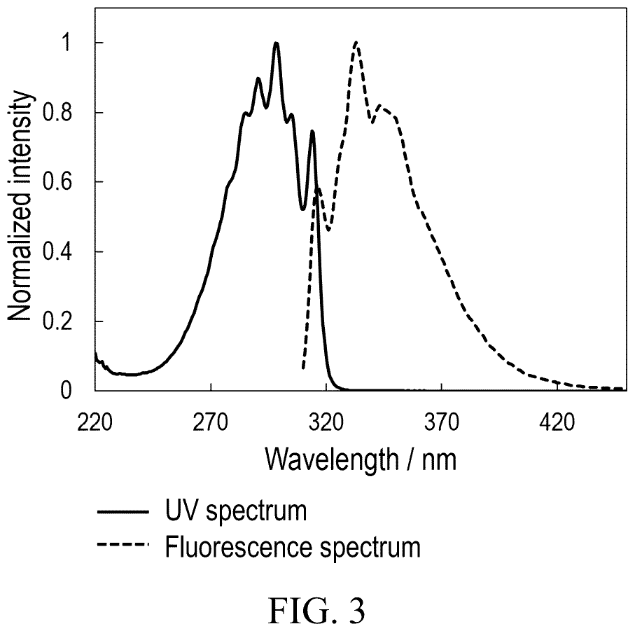

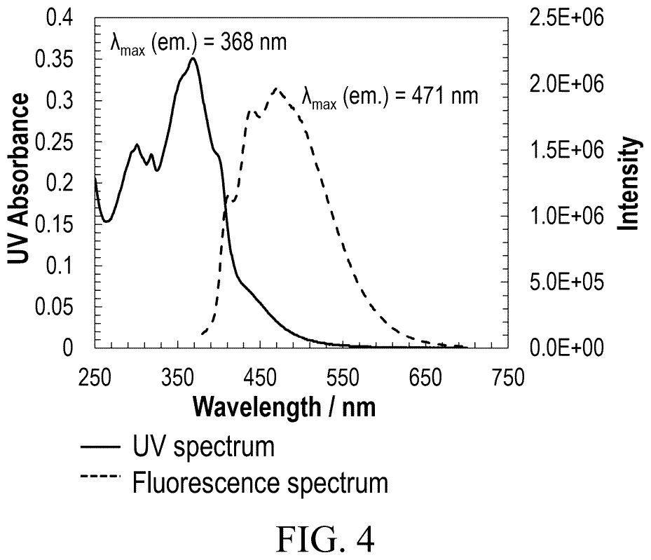

FIG. 1 shows the thus measured UV spectrum and fluorescence spectrum of 5,5′-bis(dimethylsilyl)-2,2′-bifuran; FIG. 2 shows the thus measured UV spectrum of 2,5-bis(dimethylsilyl) furan: FIG. 3 shows the thus measured UV spectrum and fluorescence spectrum of 5,5′-bis(dimethylhydroxysilyl)-2,2′-bifuran; and FIG. 4 shows the thus measured UV spectrum and fluorescence spectrum of 5,5′-bis(dimethylsilyl)-quarterfuran. It is noted here that 2,5-bis(dimethylsilyl) furan did not exhibit fluorescence emission.

Further, DFT (B3LYP/6-311++G(d.p)) calculation was performed using Gaussian09, and the thus obtained values were compared with the actual measured values. The results thereof are shown in Table 1.

TABLE 1

| | λₘₐₓ | λₘₐₓ |
|---|---|---|
| | (TD-DFT)^{a} | (exp.)^{b} |
| | (nm) | (nm) |
| 5,5′-bis(dimethylsilyl)-2,2′-bifuran | 309 | 298 |
| 2,2′-bifuran | 284 | 281^{c} |
| 2,5-bis(dimethylsilyl)furan | 236 | 227^{d} |
| 5,5′-bis(dimethylhydroxysilyl)-2,2′-bifuran | 348 | 299 |

^{a}DFT (B3LYP/6-311++G (d, p)) of Gaussian
^{b}Measured in MeCN.
^{c}literature data (J. Phys. Chem. A. 2000, 104, 6907-6911)
^{d}literature data (Polymer Bulletin. 1989, 22, 363-369)

From FIG. 1, it is seen that 5,5′-bis(dimethylsilyl)-2,2′-bifuran emitted fluorescence when irradiated with 365-nm UV light. In addition, 5,5′-bis(dimethylsilyl)-2,2′-bifuran had a maximum absorption wavelength of 298 nm in the UV spectrum, and exhibited a fluorescence maximum absorption wavelength of 335 nm when excited at 298 nm in the fluorescence measurement. From these results, the maximum absorption wavelength of 5,5′-bis(dimethylsilyl)-2,2′-bifuran was found to be shifted to the longer wavelength side than the maximum absorption wavelength of 2,2′-bifuran.

Further, 2,5-bis(dimethylsilyl) furan, which is a monofuran compound, did not exhibit fluorescence emission; therefore, a bifuran skeleton in which two furan rings are linked together was found to exhibit expansion and emission characteristics of a n-conjugated system.

Moreover, from Table 1, the Gaussian calculation results also indicate that the maximum absorption wavelength of 5,5′-bis(dimethylsilyl)-2,2′-bifuran was shifted to the longer wavelength side than the maximum absorption wavelength of 2,2′-bifuran.

According to FIG. 4, 5,5′-bis(dimethylsilyl)-quarterfuran had a maximum absorption wavelength of 368 nm in the UV spectrum, and exhibited a fluorescence maximum absorption wavelength of 471 nm. In other words, it was indicated that the maximum absorption wavelength of 5,5′-bis(dimethylsilyl)-quarterfuran was shifted to the longer wavelength side than the maximum absorption wavelength of 5,5′-bis(dimethylsilyl)-2,2′-bifuran. From this, it is seen that, in a quarterfuran skeleton in which four furan rings are linked together, the π-conjugated system is further expanded than that of a bifuran skeleton, resulting in an increase in the emission wavelength.

### [Evaluation Based on Computational Science]

For 2,2′-bifuran and 5,5′-bis(dimethylsilyl)-2,2′-bifuran obtained in Example 1, DFT (B3LYP/6-311++G(d,p)) calculation was performed using Gaussian09. The results thereof are shown in Table 2.

TABLE 2

| | HOMO | LUMO | E_{HOMO-LUMO} |
|---|---|---|---|
| | (eV) | (eV) | (eV) |
| 5,5′-bis(dimethylsilyl)-2,2′-bifuran | −5.58 | −1.30 | 4.28 |
| 2,2′-bifuran | −5.67 | −1.12 | 4.54 |

From Table 2, it was confirmed that silylation of 2,2′-bifuran caused substantially no change in the HOMO value but reduced the LUMO value, resulting in a smaller HOMO-LUMO gap. Because of a small HOMO-LUMO gap, a dihydrosilylbifuran compound has electron-transporting and light-emitting properties as an organic electronic material, and is thus believed to be applicable as an electroconductive material, an optical functional material, or the like.

### [Evaluation of Solid-State Emission Characteristics]

The dihydrosilyloligofuran compounds obtained in Examples 1, 2, and 4, and the dihydroxysilyloligofuran compound obtained in Example 3 were each irradiated with 254-nm UV light and 365-nm UV light, and the resulting emission was visually observed. The results thereof are shown in Table 3.

TABLE 3

Solid-State Emission

| | 254 nm | 365 nm |
|---|---|---|
| Example 1 | Not Observed | Not Observed |
| Example 2 | Not Observed | Not Observed |
| Example 3 | Not Observed | Not Observed |
| Example 4 | Observed | Observed |

### [Evaluation of Aggregation-Induced Emission]

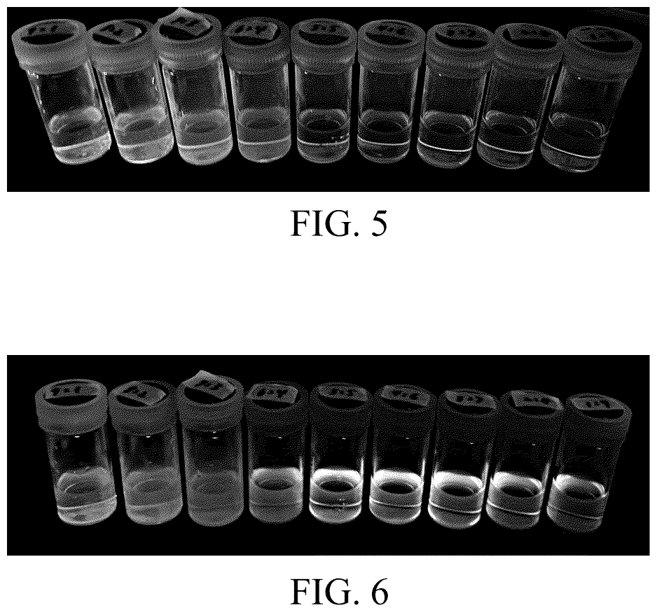

Tetrahydrofuran-water mixed solutions (0.1 mM) of 5,5′-bis(dimethylsilyl)-quarterfuran obtained in Example 4 were prepared. The thus obtained sample solutions were irradiated with 254-nm UV light and 365-nm UV light, and the resulting emission was visually observed. FIG. 5 shows the results of irradiating the sample solutions with 254-nm UV light, while FIG. 6 shows the results of irradiating the sample solutions with 365-nm UV light. In FIGS. 5 and 6, the volume ratio of tetrahydrofuran and water (tetrahydrofuran: water) in the solvent used for the preparation of the sample solutions is in the order of 9:1, 8:2, 7:3, 6:4, 5:5, 4:6, 3:7, 2:8, and 1:9 from the leftmost sample tube.

Since 5,5′-bis(dimethylsilyl)-quarterfuran does not dissolve in water, it gradually aggregates with an increase in the ratio of water in the solvent. As seen from FIGS. 5 and 6, the sample solutions in which a solvent having a tetrahydrofuran/water volume ratio of 9:1 was used hardly exhibited emission; however, emission was observed when the ratio of water in the solvent was increased. From this, it is seen that 5,5′-bis(dimethylsilyl)-quarterfuran exhibits aggregation-induced emission.

### [Evaluation of Solid Color]

The dihydrosilylbifuran compounds obtained in Examples 1 and 2, and the dihydroxysilylbifuran compound obtained in Example 3 were in the form of a white to yellow solid with no metallic luster. On the other hand, the dihydrosilyl quarterfuran compound obtained in Example 4 was in the form of a brown solid exhibiting a metallic luster.

From Table 3, it is seen that the dihydrosilyl quarterfuran compound (Example 4) exhibited aggregation-induced emission (AIE emission) that was not observed for the dihydrosilylbifuran compounds and the dihydroxysilylbifuran compound (Examples 1 to 3). In other words, the dihydrosilyl quarterfuran compound having a quarterfuran skeleton in which four furan rings were linked together was confirmed to be a compound exhibiting aggregation-induced emission.

### INDUSTRIAL APPLICABILITY

According to the production method of the present invention, a dihydrosilyloligofuran compound can be efficiently synthesized, and the resulting dihydrosilyloligofuran compound can be easily purified by distillation, sublimation, or the like, and is thus suitable for industrial production. In addition, the dihydrosilyloligofuran compound can be easily converted into a dihydroxysilyloligofuran compound.

Further, the dihydrosilyloligofuran compound and the dihydroxysilyloligofuran compound have a maximum absorption wavelength on the long wavelength side and exhibits broad light absorption characteristics; therefore, these compounds are applicable to solar cells and the like. Particularly, since a dihydrosilyl quarterfuran compound was confirmed to exhibit aggregation-induced emission, those reactive silyl group-containing oligofuran compounds that have a skeleton in which four or more furan rings are linked together are expected to be developed into light-emitting materials such as organic light-emitting device materials, as well as coating materials.

Moreover, these compounds have two hydrosilyl groups or hydroxysilyl groups that are reactive functional groups; therefore, they can be, for example, polymerized and thereby developed into polymers such as polysiloxanes, and are also expected to be applied to σ-π-conjugated system organic semiconductor materials, engineering plastics, additives for plastics, coating materials, food additives, and the like.

1. A method of producing a dihydrosilyloligofuran compound, the method comprising:
a deprotonation step of deprotonating an oligofuran compound in the presence of a deprotonating agent; and
a hydrosilylation step of allowing a deprotonated product of the oligofuran compound to react with a halohydrosilane compound,
wherein the oligofuran compound is a di- to 256-mer of a monofuran compound.

2. The method of producing a dihydrosilyloligofuran compound according to claim 1, wherein the oligofuran compound is represented by the following Formula (A′-1): 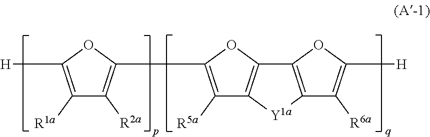
wherein, R^{1a} and R^{2a} each independently represent a hydrogen atom, an optionally substituted hydrocarbon group having 1 to 20 carbon atoms, or an optionally substituted hydrocarbonoxy group having 1 to 20 carbon atoms; when R^{1a} and R^{2a} are each the optionally substituted hydrocarbon group having 1 to 20 carbon atoms, or the optionally substituted hydrocarbonoxy group having 1 to 20 carbon atoms, R^{1a} and R^{2a} are optionally bound to each other via a direct bond or a linking group to form a ring; R^{5a} and R^{6a} each independently represent a hydrogen atom, an optionally substituted hydrocarbon group having 1 to 20 carbon atoms, or an optionally substituted hydrocarbonoxy group having 1 to 20 carbon atoms; Y^{1a} represents —CH₂—, —CHR^{7a}—, —C(R^{7a})₂-, —PR^{7a}—, —S—, —O—, —Si(R^{7a})₂-, —NR^{7a}—, or —C═C—; R^{7a} s each independently represent a hydrocarbon group having 1 to 8 carbon atoms; p represents an integer of 0 to 256; q represents an integer of 0 to 128; and p+2q is an integer of 2 to 256.

3. The method of producing a dihydrosilyloligofuran compound according to claim 1, wherein
the dihydrosilyloligofuran compound is a dihydrosilylbifuran compound, and
the oligofuran compound is a bifuran compound.

4. The method of producing a dihydrosilyloligofuran compound according to claim 3, wherein the bifuran compound is represented by the following Formula (A-1) or (A-2): 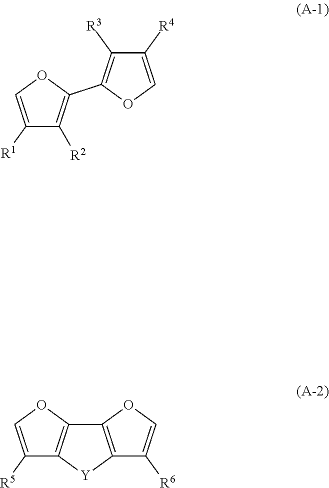
wherein, R¹ to R⁴ each independently represent a hydrogen atom, an optionally substituted hydrocarbon group having 1 to 20 carbon atoms, or an optionally substituted hydrocarbonoxy group having 1 to 20 carbon atoms; when R¹ and R² are each the optionally substituted hydrocarbon group having 1 to 20 carbon atoms, or the optionally substituted hydrocarbonoxy group having 1 to 20 carbon atoms, R¹ and R² are optionally bound to each other via a direct bond or a linking group to form a ring; when R³ and R⁴ are each the optionally substituted hydrocarbon group having 1 to 20 carbon atoms, or the optionally substituted hydrocarbonoxy group having 1 to 20 carbon atoms, R³ and R⁴ are optionally bound to each other via a direct bond or a linking group to form a ring; R⁵ and R⁶ each independently represent a hydrogen atom, an optionally substituted hydrocarbon group having 1 to 20 carbon atoms, or an optionally substituted hydrocarbonoxy group having 1 to 20 carbon atoms; Y represents —CH₂—, —CHR⁷—, —C(R⁷)₂—, —PR⁷—, —S—, —O—, —Si(R⁷)₂—, —NR⁷—, or —C═C—; and R⁷s each independently represent a hydrocarbon group having 1 to 8 carbon atoms.

5. The method of producing a dihydrosilyloligofuran compound according to claim 1, wherein the halohydrosilane compound is represented by the following Formula (B): 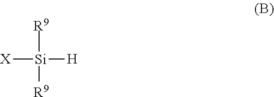
wherein, R⁹s each independently represent a hydrogen atom, an optionally substituted hydrocarbon group having 1 to 20 carbon atoms, or an optionally substituted hydrocarbonoxy group having 1 to 20 carbon atoms; and X represents a halogen atom.

6. The method of producing a dihydrosilyloligofuran compound according to claim 1, wherein the deprotonating agent is an organic alkali metal compound.

7. A method of producing a dihydroxysilyloligofuran compound, the method comprising:
a dihydrosilyloligofuran compound production step of producing a dihydrosilyloligofuran compound by the method according to claim 1; and
a hydroxysilylation step of allowing the dihydrosilyloligofuran compound to react with water in the presence of a transition metal catalyst,
wherein the transition metal catalyst is at least one selected from the group consisting of a palladium catalyst, a rhodium catalyst, and a platinum catalyst.

8. A reactive silyl group-containing oligofuran compound represented by the following Formula (C′-1) or (D′-1): 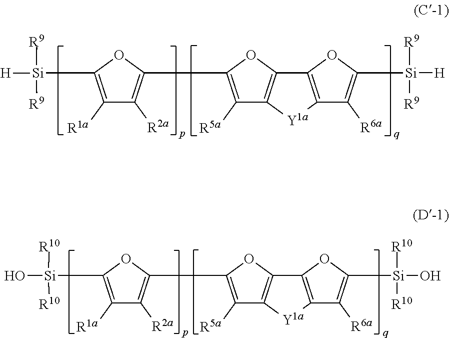
wherein, R^{1a} and R^{2a} each independently represent a hydrogen atom, an optionally substituted hydrocarbon group having 1 to 20 carbon atoms, or an optionally substituted hydrocarbonoxy group having 1 to 20 carbon atoms; when R^{1a} and R^{2a} are each the optionally substituted hydrocarbon group having 1 to 20 carbon atoms, or the optionally substituted hydrocarbonoxy group having 1 to 20 carbon atoms, R^{1a} and R^{2a} are optionally bound to each other via a direct bond or a linking group to form a ring; R^{5a} and R^{6a} each independently represent a hydrogen atom, an optionally substituted hydrocarbon group having 1 to 20 carbon atoms, or an optionally substituted hydrocarbonoxy group having 1 to 20 carbon atoms; Y^{1a} represents —CH₂—, —CHR^{7a}-, —C(R^{7a})₂-, —PR^{7a}—, —S—, —O—, —Si(R^{7a})₂-, —NR^{7a}-, or —C═C—; R^{7a}s each independently represent a hydrocarbon group having 1 to 8 carbon atoms; p represents an integer of 0 to 256; q represents an integer of 0 to 128; p+2q is an integer of 2 to 256; R's each independently represent a hydrogen atom, an optionally substituted hydrocarbon group having 1 to 20 carbon atoms, or an optionally substituted hydrocarbonoxy group having 1 to 20 carbon atoms; and R¹⁰s each independently represent a hydroxy group, an optionally substituted hydrocarbon group having 1 to 20 carbon atoms, or an optionally substituted hydrocarbonoxy group having 1 to 20 carbon atoms.

9. A reactive silyl group-containing bifuran compound represented by the following Formula (C-1), (C-2), (D-1), or (D-2): 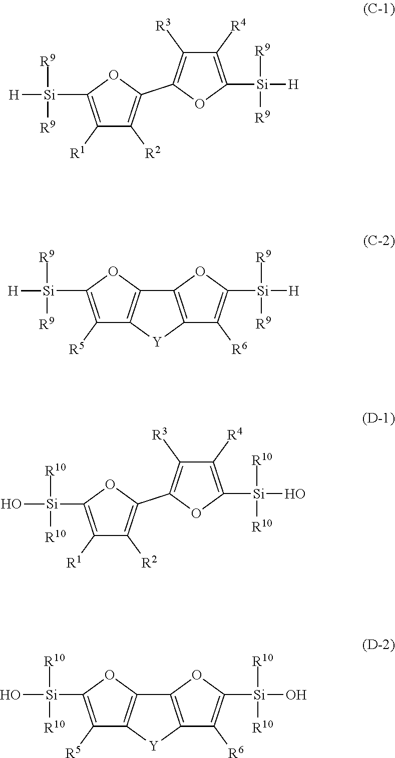
wherein, R¹ to R⁴ each independently represent a hydrogen atom, an optionally substituted hydrocarbon group having 1 to 20 carbon atoms, or an optionally substituted hydrocarbonoxy group having 1 to 20 carbon atoms; when R¹ and R² are each the optionally substituted hydrocarbon group having 1 to 20 carbon atoms, or the optionally substituted hydrocarbonoxy group having 1 to 20 carbon atoms, R¹ and R² are optionally bound to each other via a direct bond or a linking group to form a ring; when R³ and R⁴ are each the optionally substituted hydrocarbon group having 1 to 20 carbon atoms, or the optionally substituted hydrocarbonoxy group having 1 to 20 carbon atoms, R³ and R⁴ are optionally bound to each other via a direct bond or a linking group to form a ring; R⁵ and R⁶ each independently represent a hydrogen atom, an optionally substituted hydrocarbon group having 1 to 20 carbon atoms, or an optionally substituted hydrocarbonoxy group having 1 to 20 carbon atoms; Y represents —CH₂—, —CHR⁷—, —C(R⁷)₂—, —PR⁷—, —S—, —O—, —Si(R⁷)₂—, —NR⁷—, or —C═C—; R⁷s each independently represent a hydrocarbon group having 1 to 8 carbon atoms; R's each independently represent a hydrogen atom, an optionally substituted hydrocarbon group having 1 to 20 carbon atoms, or an optionally substituted hydrocarbonoxy group having 1 to 20 carbon atoms; and R¹⁰s each independently represent a hydroxy group, an optionally substituted hydrocarbon group having 1 to 20 carbon atoms, or an optionally substituted hydrocarbonoxy group having 1 to 20 carbon atoms.
